(19) United States
(12) Patent Application Publication
(10) Pub. No.: US 2022/0212993 A1
(43) Pub. Date: Jul. 7, 2022

(54) PASTE COMPRISING AMORPHOUS CALCIUM CARBONATE AND DRY 3D MODELS PREPARED THEREFROM

(71) Applicant: Technion Research and Development Foundation Ltd, Haifa (IL)

(72) Inventors: Boaz POKROY, Haifa (IL); Hadar SHAKED, Haifa (IL); Iryna POLISHCHUK, Haifa (IL)

(21) Appl. No.: 17/646,648

(22) Filed: Dec. 30, 2021

Related U.S. Application Data
(60) Provisional application No. 63/134,277, filed on Jan. 6, 2021.

(51) Int. Cl. C04B 22/10; C04B 26/04; B28B 1/00; B33Y 10/00; B33Y 70/00; B33Y 80/00; B33Y 40/20

(52) U.S. Cl. CPC C04B 22/10; C04B 26/04; B28B 1/001; B33Y 40/20; B33Y 70/00; B33Y 80/00; B33Y 10/00

(57) ABSTRACT

The present invention relates to a paste comprising amorphous calcium carbonate (ACC) doped with divalent alkaline-earth metal ions, e.g., magnesium ions, or transition metal ions: a dry three-dimensional model made of such a paste, e.g., by 3D-printing process such as robocasting 3D-printing process; and a process for the preparation of said paste.

### CROSS REFERENCE TO RELATED APPLICATIONS

This application claims the benefit under 35 USC § 119(e) of U.S. Patent Application No. 63/134,277, filed on Jan. 6, 2021, which is hereby incorporated by reference 37 CFR 1.57.

### TECHNICAL FIELD

The present invention relates to a paste comprising amorphous calcium carbonate (ACC) doped with divalent alkaline-earth metal ions or transition metal ions; a dry three-dimensional model made of such a paste; and a process for the preparation thereof.

### BACKGROUND

Calcium carbonate (CaCO₃) is the biomineral most abundantly used by various organisms to form skeletons, protective shells, teeth, and optical lenses. While the commonest thermodynamically stable polymorphs of biogenic CaCO₃ are calcite and aragonite, the metastable polymorph amorphous calcium carbonate (ACC) has gained increasing interest owing to its widespread function as a precursor to crystalline CaCO₃. As a precursor, ACC leads to the formation of crystals exhibiting unique morphologies and enhanced physical properties. Amorphous-to-crystalline transformation is known to facilitate the incorporation of organic and inorganic additives. Mg is a common impurity in biogenic CaCO₃, and in biogenic calcite, it can reach up to 40 at. %, a value substantially higher than its thermodynamic solubility limit (˜2 at. %). Incorporation of Mg is known to stabilize ACC, as well as to tune the hardness and change the morphology of the formed crystals; in addition, it induces lattice distortions. The ability to mimic the formation of intricately shaped crystals incorporating high amounts of various chemical species would be of great interest to materials scientists. The stability of intracrystalline organic additives is poor at elevated temperatures (Polishchuk et al., 2017; Seknazi et al., 2019). Our approach does not require processing at elevated temperatures, thereby enabling the preservation of both the intricate shapes and the presence of even organic additives in the final crystalline lattice. Here, for the first time, we demonstrate long-term stabilization of ACC under ambient conditions, thereafter, used to form an easily handled amorphous ink, and utilize it to form three-dimensional (3D) models via an emerging technique of 3D printing. Bio-inspired 3D printing of ACC models may shed more light on the advantages of this phase from a materials point of view and deepen our understanding of the non-classical crystallization route commonly found in nature.

3D printing is a revolutionary manufacturing technique already used in various fields. Given the growing demand for ceramic materials, several 3D printing methods have been developed for the fabrication of ceramic products (Chen et al., 2019b). Powder-based printing exploits the ability of a powder to bond in different media by using either laser sintering or chemical binders. Solid-based techniques use solidified laser-cut thin sheets of ceramics as per computed design, later layered and laminated together or by using ceramic powders bonded to thermoplastic polymers to form a flexible composite filament. Liquid-based techniques use photoreactive polymeric resins with embedded ceramic powders. Robocasting is an additive manufacturing technique that is applicable in a wide variety of ceramic materials. Using this technique, a preprepared semiliquid paste with high ceramic loading is extruded through a thin nozzle (Peng et al., 2018). The paste is required to provide an appropriate viscosity under stress, allowing self-support and extrudability, and it should contain only a few, if any, agglomerates and a binder which, if required, can be easily removed after use (Travitzky et al., 2014). The standard ceramic robocasting procedure forms a green body, a weakly bound mixture of a powder and an organic or inorganic additive, that usually requires high-temperature sintering. However, in our case, we eliminate the need in post-printing sintering and enable low temperature hardening of the printed material instead. Overcoming this limitation will enable incorporation and preservation of various organic additives in a composite functional material which can be further used in a variety of applications such as cultural heritage reconstruction, artificial reef formation, and bio-medical engineering (e.g., drug delivery).

Studies have revealed the potential inherent in bio-inspired 3D printing. Formation of highly porous ceramics inspired by wood and bones, formation of hierarchical crack-controlled materials resembling nacre and spider silk, and formation of superhydrophobic materials inspired by the lotus flower are just a few examples. Bio-inspired 3D printing of crystalline calcium salts has focused mainly on calcium phosphates because of their abundance in natural organisms and their compatibility with bone-implant applications. Currently, usage of CaCO₃ in 3D printing is mainly limited to crystalline powders bonded with aqueous binders (Mohan et al., 2020; Leu et al., 2012). Up to now, 3D printing of ACC has been contraindicated by its heat intolerance as well as by its inability to stabilize for long periods of time.

### SUMMARY OF INVENTION

In one aspect, the present invention provides a paste comprising ACC doped with divalent alkaline-earth metal ions, e.g., Mg ions, or transition metal ions, e.g., Zn or Mn ions, a binder, and optionally a dispersant.

In another aspect, the present invention provides a dry three-dimensional (3D) model, i.e., structure or object, prepared from, i.e., made of, a paste as defined above.

In a further aspect, the present invention relates to a process for the preparation of a paste as defined above, i.e., a paste comprising ACC doped with divalent alkaline-earth metal ions, e.g., Mg ions, or transition metal ions, e.g., Zn or Mn ions, a binder, and optionally a dispersant, said process comprising the steps of:
(i) mixing an aqueous solution containing calcium ions and an aqueous solution containing said divalent alkaline-earth- or transition metal ions, to obtain a solution, and then adding an aqueous solution containing carbonate ions, optionally while stirring, to obtain a suspension;
(ii) filtering said suspension to obtain a filtered powder;
(iii) washing said filtered powder and consequently drying it;
(iv) grinding the dried powder obtained in step (iii) and optionally mixing with said dispersant; and
(v) mixing the product obtained in step (iv) with said binder to obtain said paste.

In certain embodiments, said process further comprises the steps of:
(vi) printing a 3D model using a 3D-printing process, e.g., a robocasting 3D-printing process; and
(vii) drying said model to obtain a crystalline CaCO₃ doped with said divalent alkaline-earth- or transition metal ions.

### BRIEF DESCRIPTION OF DRAWINGS

FIGS. 1A-1F show (1A) XRD patterns collected at a wavelength of Cu K-α 1.5406 Å from ‘as synthesized’ (0 h) powdered ACC after its storage in acetone excess for 2 days, 1 week and 2 weeks. Diffraction patterns are compared with those of crystalline calcite. (1B) HR-SEM image demonstrating the morphology of obtained ACC. (1C) Viscosity of prepared 50/50 pastes as a function of time for a constant shear rate. The decrease in viscosity over time until a plateau is reached is consistent with non-Newtonian shear-thinning materials (Ryabenkova et al., 2017; Murali Krishnan et al., 2010). (1D-1F) 50/50 ACC printed models from EG paste forming the word “ACC”, (1D) immediately after printing, (1E) after low-temperature sintering, and (1F) after crystallization treatment in an autoclave, sample height, 6 mm.

FIG. 2 shows HR-SEM images of the 3D-printed models after sintering (panels A-C, with glycerol (GLY) binder; panels D-F, with ethylene glycol (EG) binder; and panels G-I, with triethylene glycol (TEG) binder). Insets in panels B and C show magnified images of the ‘feeding-stock’ phenomenon.

FIG. 3 shows HR-SEM images showing changes in morphology after autoclave treatment (panels A-C, with GLY binder; panels D-F, with EG binder; and panels G-I, with TEG binder).

FIG. 4 shows levels of Mg incorporation (in at %) within the final crystalline CaCO₃ structure after oven sintering.

FIG. 5 shows the (104) diffraction peak of calcite (XRD patterns collected at a wavelength of Cu K-α 1.5406 Å). Panels A-C, after oven treatment; and panels D-F, after autoclave treatment.

FIGS. 6A-6F shows full spectrum of the powdered samples (6A-6C, after oven treatment; and panels 6D-6F, after autoclave treatment). Peaks at 38.5 and 44.7 correspond the sample's Aluminum holder.

FIG. 7 shows crystallite sizes of the calcite crystalline phases formed after autoclave treatment reveals the dependency of crystallite size on the type of binder used.

### DETAILED DESCRIPTION OF INVENTION

Amorphous calcium carbonate (ACC) is a meta-stable phase which crystallizes rapidly in mild-humid environments. Stabilization of ACC for long-term uses was only available through complex synthesis routes with little outcome product which disabled any further bulk manufacturing. This has led to the inability to form elaborate structures and limited the ability to fully investigate the mechanical properties of this phase and the benefits it may hold for the organisms that use it.

Here, by using the robocasting method, we present an innovative route to the bio-inspired 3D printing of high-Mg ACC, and introduce a novel storage protocol that allows maintaining the amorphous nature of ACC powder for at least several days. In contrast to current technologies, the approach disclosed herein involves sintering at low temperatures (relatively to classic sintering) and on-demand crystallization.

The present invention enables stabilization of ceramic ACC as a paste, using common organic binders, and formation of complex geometries from it by 3D printing techniques. The printed model is solidified under relatively low temperatures, e.g., using a vacuum oven, and crystallizes on demand in aqueous environment. This allows the development of intriguing structures similar to those seen in nature, following similar crystallization routes. Structures formed by the process disclosed herein have the capacity to act as “storage” for incorporated molecules and may be used for various applications such as drug delivery systems, and scaffolds and cement substitutions, as well as for formation of bio-inspired materials.

In one aspect, the present invention provides a paste comprising ACC doped with divalent alkaline-earth metal ions or transition metal ions, a binder, and optionally a dispersant.

The term “paste” as used herein refers to a soft, viscous mass of solids (i.e., particles of ACC doped with divalent alkaline-earth- or transition metal ions) dispersed in a liquid, i.e., to a suspension of granular material in a background fluid, more specifically to a substance as defined above (viscoplastic material) that is a moldable body which becomes more fluid (less viscous) at high stresses.

The term “alkaline-earth metal” as used herein refers to any of the elements included in group 2 of the Periodic Table other than calcium, i.e., beryllium (Be), magnesium (Mg), strontium (Sr), barium (Ba), and radium (Ra).

The term “transition metal” as used herein refers to any of the elements in the d-block of the Periodic Table, which includes groups 3-12 on said table, as well as to the elements of the f-block lanthanide and actinide series also referred to as “inner transition metals”. Examples of transition metals include, without limiting, zinc (Zn) and manganese (Mn).

In certain aspects, disclosed herein is a paste comprising ACC doped with divalent alkaline-earth metal ions such as Mg ions. In other aspects, the invention provides a paste comprising ACC doped with transition metal ions such as Zn or Mn ions. In particular such embodiments, the paste disclosed comprises ACC doped with Mg ions.

In certain embodiments, the binder comprised within the paste of the present invention comprises a polar organic solvent or a mixture thereof. Particular polar organic solvents for use as binders include, without being limited to, alcohols including inter alia diols, i.e., glycols, and polyols, e.g., ethoxymethanol, ethoxyethanol, ethylene glycol, triethylene glycol, propylene glycol, glycerol, and pentaerythritol, as well as dimethylformamide (DMF) and dimethyl sulfoxide (DMSO). Other suitable binders may comprise a mixture of a glycol with a polymer such as polyvinyl alcohol (PVA), glucose, a cellulose derivative, collagen, gelatin, chitin derivatives, and a poloxamer copolymer.

The term “poloxamer copolymer” as used herein denotes a polyethoxy/polypropoxy block copolymer, i.e., a nonionic triblock copolymer composed of a central hydrophobic chain of polyoxypropylene (poly(propylene oxide)) flanked by two hydrophilic chains of polyoxyethylene (poly(ethylene oxide)). Particular examples of such poloxamers include, without being limited to, poloxamer 407, poloxamer 188, poloxamer 124, poloxamer 237, poloxamer 338, or a mixture thereof.

In certain embodiments, the dispersant optionally comprised within the paste of the present invention is an oil such as a vegetable oil, e.g., corn oil, coconut oil, canola oil, and sunflower oil, fish oil, and oil paint; glycerol; or a mixture thereof. In particular embodiments, the dispersant comprised within said paste is a vegetable oil, e.g., corn oil, coconut oil, canola oil, and sunflower oil.

In certain embodiments, the ratio between the doped ACC composing the paste of the invention and the dispersant, when present, may be about 1 gram to up to 0.25 mL (i.e., 1 gram to 0-0.25 mL), respectively; and the ratio between the doped ACC and the total volume of said dispersant and said binder in said paste (regardless of whether said dispersant is present or absent) is about 1-2 gram to 1 mL, respectively.

In certain embodiments, the ratio between the calcium ions of said CaCO₃ and the divalent alkaline-earth- or transition metal ions, composing the paste of the invention, is from about 4:1 to about 1:1, e.g., about 4:1, about 3.5:1, about 3:1, about 2.5:1, about 2:1, about 1.5:1, or about 1:1, respectively. In particular embodiments, the ratio between said calcium ions and said divalent alkaline-earth- or transition metal ions is about 1:1.

In certain embodiments, disclosed herein is a paste as defined above, comprising ACC doped with Mg ions; ethylene glycol or triethylene glycol as said binder; and a vegetable oil, e.g., corn oil, as said dispersant, wherein the ratio between the calcium ions of said CaCO₃ and said Mg ions is from about 4:1 to about 1:1, e.g., about 4:1, about 3.5:1, about 3:1, about 2.5:1, about 2:1, about 1.5:1, or about 1:1, respectively, preferably about 1:1. Particular such embodiments are those wherein the ratio between the doped ACC and said dispersant is about 1 gram to up to 0.25 mL, e.g., about 1 gram to about 0.1, 0.12, 0.14, 0.16, 0.18, or 0.2 mL, respectively; and the ratio between the doped ACC and the total volume of said dispersant and said binder (regardless of whether said dispersant is present or absent) is about 1-2 gram to 1 mL, e.g., about 1 gram to about 1, 0.8, 0.67 or 0.5 mL, respectively.

In certain embodiments, disclosed herein is a paste as defined in any one of the embodiments above, having a viscosity in the range of about 2×10⁵ to about 5×10⁵ centipoise (cP), e.g., 2.64×10⁵ to 3.94×10⁵ cP, at a temperature of 25° C. and a constant shear rate of 10 sec⁻¹.

In another aspect, the present invention provides a dry three-dimensional (3D) model, i.e., structure or object, prepared from, i.e., made of, a paste as defined in any one of the embodiments above.

In certain embodiments, the dry 3D model disclosed herein is made of a paste comprising ACC doped with Mg ions; ethylene glycol or triethylene glycol as said binder; and a vegetable oil, e.g., corn oil, as said dispersant, wherein the ratio between the calcium ions of said CaCO₃ and said Mg ions is from about 4:1 to about 1:1, e.g., about 4:1, about 3.5:1, about 3:1, about 2.5:1, about 2:1, about 1.5:1, or about 1:1, respectively, preferably about 1:1. In particular such embodiments, said model is made of a such a paste, wherein the ratio between the doped ACC and said dispersant is about 1 gram to up to 0.25 mL, e.g., about 1 gram to about 0.1, 0.12, 0.14, 0.16, 0.18, or 0.2 mL, respectively; and/or the ratio between the doped ACC and the total volume of said dispersant and said binder (regardless of whether said dispersant is present or absent) is about 1-2 gram to 1 mL, e.g., about 1 gram to about 1, 0.8, 0.67 or 0.5 mL, respectively. More particular such embodiments are those wherein said paste has a viscosity in the range of about 2×10⁵ to about 5×10⁵ cP, e.g., 2.64×10⁵ to 3.94×10⁵ cP, at a temperature of 25° C. and a constant shear rate of 10 sec⁻¹.

The dry 3D model of the present invention may be prepared by any process comprising a 3D-printing process, e.g., by robocasting 3D-printing process as exemplified herein.

In a further aspect, the present invention relates to a process for the preparation of a paste as defined in any one of the embodiments above, i.e., a paste comprising ACC doped with divalent alkaline-earth- or transition metal ions, a binder, and optionally a dispersant, said process comprising the steps of:
(i) mixing an aqueous solution containing calcium ions and an aqueous solution containing said divalent alkaline-earth- or transition metal ions, to obtain a solution, and then adding an aqueous solution containing carbonate ions, optionally (but preferably) while stirring, to obtain a suspension;
(ii) filtering said suspension to obtain a filtered powder;
(iii) washing said filtered powder and consequently drying it;
(iv) grinding the dried powder obtained in step (iii) and optionally mixing with said dispersant; and
(v) mixing the product obtained in step (iv) with said binder to obtain said paste.

In certain embodiments, the process disclosed herein is for the preparation of a paste comprising ACC doped with Mg ions, a binder, and optionally a dispersant, and the aqueous solutions mixed in step (i) of said process are CaCl₂.2H₂O, MgCl₂.6H₂O, and Na₂CO₃ solutions.

In certain embodiments, the ratio between the calcium ions, and said divalent alkaline-earth- or transition metal ions in the aqueous solutions mixed in step (i) is from about 4:1 to about 1:1, e.g., about 4:1, about 3.5:1, about 3:1, about 2.5:1, about 2:1, about 1.5:1, or about 1:1, respectively. In particular embodiments, the ratio between said calcium ions and said divalent metal ions is about 1:1.

In certain embodiments, the filtered powder obtained in step (ii) is washed in step (iii) with water, and optionally an organic solvent so as to accelerate drying afterwards. Examples of suitable organic solvents to be used include, without limiting, acetone, isopropanol, and diethyl-ether. According to the present invention, drying of the washed filtered powder may be carried out at any temperature and under either atmospheric pressure or vacuum. In particular embodiments, drying of the filtered powder, after washing, is carried out at room temperature, optionally (but preferably) under vacuum.

The dried powder obtained in step (iii) of the process disclosed herein is grinded and optionally mixed with a dispersant, and the product thus obtained is then mixed with a binder as defined above to obtain said paste. As defined above, said dispersant may be an oil such as a vegetable oil, e.g., corn oil, coconut oil, canola oil, and sunflower oil, fish oil, and oil paint, glycerol, or any mixture thereof. According to the present invention, said binder may comprise a polar organic solvent such as an alcohol including inter alia a glycol and polyol, as well as DMF and DMSO, or a mixture thereof. Examples of suitable alcohols are listed above. Other suitable binders may comprise a mixture of a glycol with a polymer such as PVA, glucose, a cellulose derivative, collagen, gelatin, chitin derivatives, and a poloxamer copolymer.

In certain embodiments, the ratio between the grinded powder obtained in step (iv) and said dispersant, when mixed with said powder, is 1 gram to up to 0.25 mL, e.g., about 1 gram to about 0.1, 0.12, 0.14, 0.16, 0.18, or 0.2 mL, respectively; and/or the ratio between said grinded powder and the total volume of said dispersant and said binder mixed therewith (regardless of whether said dispersant is present or absent) is about 1-2 gram to 1 mL, e.g., about 1 gram to about 1, 0.8, 0.67 or 0.5 mL, respectively.

In certain embodiments, the process disclosed herein is for the preparation of a paste comprising ACC doped with Mg ions, a binder, and a dispersant, and comprises the steps of:
(i) mixing an aqueous CaCl₂.2H₂O solution and an aqueous MgCl₂.6H₂O solution, and adding to the solution thus obtained an aqueous Na₂CO₃ solution, while stirring, to obtain a suspension;
(ii) filtering said suspension to obtain a filtered powder;
(iii) washing said filtered powder with water, and optionally an organic solvent such as acetone, isopropanol, and diethyl-ether, and consequently drying it;
(iv) grinding the dried powder obtained in step (iii) and mixing with a dispersant such as an oil, glycerol, or a mixture thereof; and
(v) mixing the product obtained in step (iv) with a binder such as a polar organic solvent or a mixture thereof, to obtain said paste.

In particular such embodiments, the dispersant used in the process disclosed herein is a vegetable oil such as corn oil, and the binder used is ethylene glycol or triethylene glycol, wherein the ratio between the Ca ions and the Mg ions in the aqueous solutions first mixed in step (i) is from about 4:1 to about 1:1, e.g., about 4:1, about 3.5:1, about 3:1, about 2.5:1, about 2:1, about 1.5:1, or about 1:1, respectively, preferably about 1:1. More particular such embodiments are those wherein the ratio between the grinded powder obtained in step (iv) and said dispersant is 1 gram to up to 0.25 mL, e.g., about 1 gram to about 0.1, 0.12, 0.14, 0.16, 0.18, or 0.2 mL, respectively; and/or the ratio between said grinded powder and the total volume of said dispersant and said binder mixed therewith (regardless of whether said dispersant is present or absent) is about 1-2 gram to 1 mL, e.g., about 1 gram to about 1, 0.8, 0.67 or 0.5 mL, respectively.

In certain embodiments, the process disclosed herein, according to any one of the embodiments above, further comprises the steps of:
(vi) printing a 3D model using a 3D-printing process, e.g., a robocasting 3D-printing process; and
(vii) drying said model to obtain a crystalline CaCO₃ doped with said divalent alkaline-earth- or transition metal ions.

According to the present invention, drying of the 3D model printed may be carried out by any suitable method. In particular embodiments, said drying is carried out by sintering at a temperature not exceeding 200° C., e.g., at about 140° C.-160° C., under vacuum condition; and/or using an autoclave and/or a vacuum oven.

Unless otherwise indicated, all numbers expressing, e.g., amounts of components or ratios between components, used in this specification, are to be understood as being modified in all instances by the term “about”. Accordingly, unless indicated to the contrary, the numerical parameters set forth in this specification are approximations that may vary by up to plus or minus 10% depending upon the desired properties to be obtained by the present invention.

The invention will now be illustrated by the following non-limiting Examples.

### EXAMPLES

### Materials and Methods

Powder preparation. Aqueous solutions of CaCl₂.2H₂O (73.5 g, 0.5 L), MgCl₂.6H₂O (101.655 g, 0.5 L), and Na₂CO₃ (52.995 g, 0.5 L) at 1M concentration were prepared and stored overnight at 8° C. A total of 50/50, 60/40, and 70/30 ratios of Ca:Mg solutions were mixed in a glass beaker for 5 min. An equivalent amount of Na₂CO₃ solution was added to the beaker with active mixing, preserving a 1:1 ion ratio of CO₃⁻² and (Ca⁺²+Mg⁺²). The suspension was rapidly filtered through a Buchner funnel with grade 5 Whatman filter paper, followed by washing with water and acetone. After remaining under suction for 10 min, the filtered powder was dried for 3 hours in a vacuum oven at 25° C., 0.1 MPa. Storage of the dried ACC powder was maintained by its submergence in an excess of acetone.

Paste preparation. Stored powder was dried, grounded with a mortar and pestle, and then mixed with a dispersant (comprising commercial corn oil (Shaneield, 1995) at a fixed ratio of 0.1 ml per 1 g of powder) and varying amounts of three different binders, ethylene glycol (EG) (99.8%, AR, Merck), triethylene glycol (TEG) (>99%, Merck), and glycerol (GLY) (anhydrous, 99.5%, AR, Bio-Lab Ltd.). The powder was slowly added to the binder and was hand mixed until a solid firm paste was obtained. Solids loading of the mixed paste was kept between 55 and 65%, i.e., 1 g of powder for 0.5-0.8 ml of dispersant-binder mixture.

3D printing after treatment. 3D models were printed using the commercially available Hyrel 3D Engine-SR printer with KR2-15 stainless steel extrusion head with a 1-mm nozzle. 3D computer-aided design (3D-CAD) of the printed models was sketched using Fusion 360 (Autodesk). The 3D-CAD was converted to an STL file, which was uploaded to the printer, where it was sliced, and the G-code was written. The printed models were placed in a vacuum oven for low-temperature sintering overnight at 150° C., 0.1 MPa. The dry models were then transferred to the autoclave for the final crystallization step under humid conditions for 1 h at 100° C., 0.1 MPa, with relative humidity (RH) of 97%, where the remaining 3% are of moisture. Later, the models were dried in a vacuum oven for 3 h at 75° C., 0.1 MPa.

High-resolution scanning electron microscopy (HR-SEM). Samples were imaged using the Zeiss Ultra-Plus FEG-SEM, at 1-2 keV with 4-4.2 mm working distance. Energy-dispersive spectroscopy (EDS) was preformed after carbon coating at 7 kV.

X-ray diffraction (XRD). Diffraction patterns of powdered samples were acquired using the Rigaku SmartLab 9 kW high-resolution diffraction system at a wavelength of Cu K-α 1.5406 Å wavelength and the Rigaku Miniflex benchtop powder XRD instrument at a wavelength of Cu K-α 1.5406 Å.

Optical microscopy. Samples were imaged using the Olympus BX51 optical microscope with reflected light at ×5-×20 magnifications.

Confocal microscopy. Sample roughness was measured using the Leica DCM 3D confocal microscope at ×5 magnification.

Rheology. Viscosity of the pastes was examined using the HR-2 Discovery Hybrid Rheometer, in rotational mode. Rheological measurements were performed at room temperature (25° C.) at constant shear of 10 s⁻¹ with at least 3 replicates preformed for each test. Approximately 1 cm³ of paste was used in each experiment in a plate-plate geometry with 8-mm diameter. The gap between the plates was set to 1.3 mm

### Results and Discussion

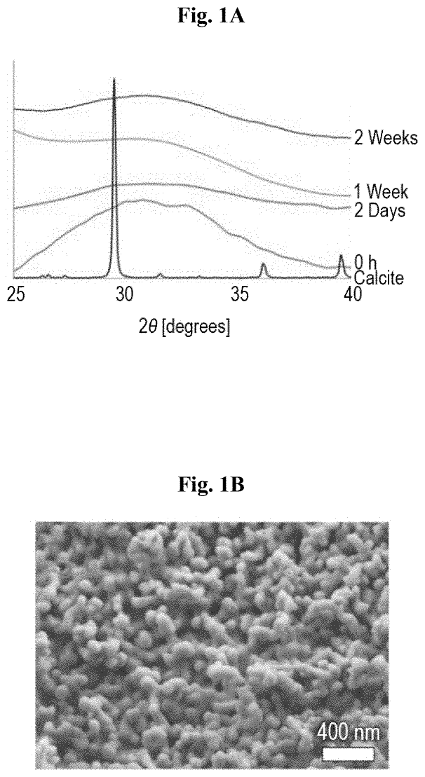

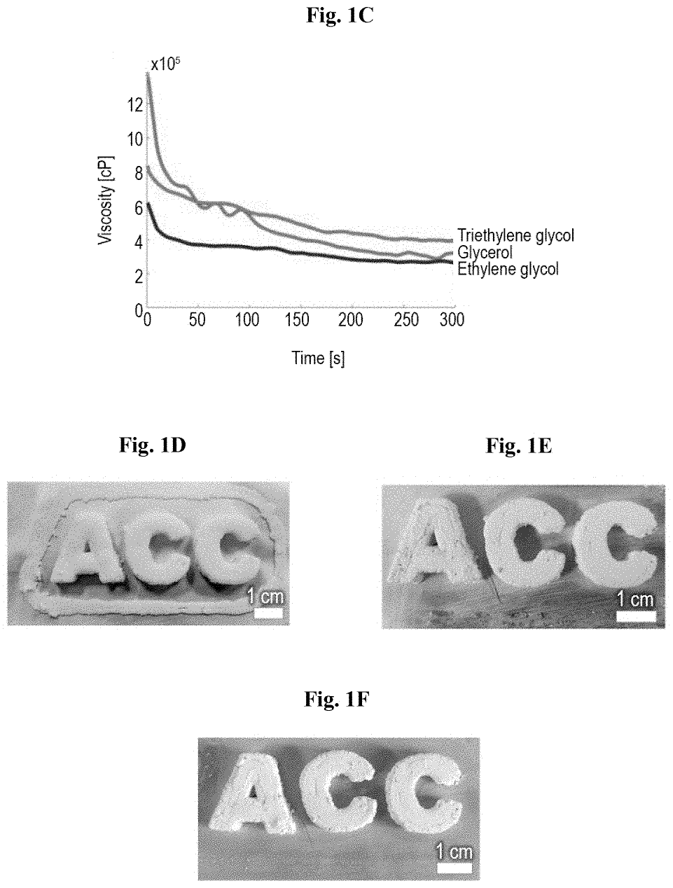

Preparation of printable, Mg stabilized ACC paste and its viscosity. ACC was precipitated from solution in the presence of Mg. Different Ca:Mg ratios were tested, preserving a 1:1 ion ratio between CO₃⁻² and (Ca⁺²+Mg⁺²). Each sample was labeled as per the Ca:Mg ratio used in the mixture, where 50/50 means 50% Ca solution and 50% Mg solution (e.g., 50 ml CaCl₂, 50 ml MgCl₂, and 100 ml NaCO₃ comprise 200 ml of sample solution), the 60/40 and 70/30 solutions were labeled accordingly. Mixing of the solutions resulted in the immediate precipitation of ACC. High amounts of ACC were synthesized from 1 M stock solutions, resulting in a yield of 92%. To accumulate the amount of powder needed for 3D printing, an appropriate storage method was needed. We found that ACC powders, when stored in an excess of acetone, remain amorphous for long periods of time. This storage protocol enabled obtaining up to 40 gr of stabilized ACC in one experimental batch. As evidenced by XRD patterns, the amorphous nature of ACC powder was preserved for 2 weeks after synthesis (FIG. 1A) by its storage in an excess of acetone. Morphology of the synthesized ACC is depicted in FIG. 1B. To prepare a printable paste, ACC powder was individually mixed with a dispersant (corn oil) and one of the three different binders—GLY, EG, and TEG. The dispersant and the binders present a non-toxic, non-volatile behavior at room temperature, allowing the facile formation of paste and a green printing process. All selected materials are non-hydrous, allowing the conservation of the amorphous nature. Viscosities of the 50/50 resultant pastes were measured. Viscosity, among other parameters, is crucial in a printable paste that must be extrudable, non-phase-separating, durable, and easily handled. The pastes prepared as described previously undergo changes in viscosity over time. For a constant shear rate, a non-Newtonian shear-thinning behavior was observed here, with viscosities ranging from 264,000 to 394,000 [cP], consistent with ceramic pastes with high solids loading (Ryabenkova et al., 2017; Murali Krishnan et al., 2010; Zima et al., 2017). No phase separation was observed in our pastes (FIG. 1C). Solids loading (i.e., the amount of suspended solids in a paste) has been shown to influence the final density of sintered ceramics (Ferreira and Diz, 1999). High solids loadings are known to have a central role in the mechanical properties of the final product, resulting in a firmer and more stress-resilient ceramic part (Wei et al., 2018; Chen et al., 2019a). High solids-loading pastes (>65%) were difficult to measure as they cracked when applied with initial shear force and were not easy to handle. Lower solids-loading pastes (<55%) could not be extruded without forcing phase separation. These findings led us to choose solids loadings of 55-65% to prevent undesirable results.

3D printing. 3D printing of the prepared pastes was performed on aluminum foil. Folded aluminum foil was fixated to the printer's print bed for fast and easy transfer to the succeeding steps. The printing resolution was limited by the nozzle head used, which allowed accuracy within 1 mm Initially, two ‘skirts’ were printed around each model to allow priming of the extruder, thereby ensuring smooth and stable flow. The ACC models were then printed and transferred to a vacuum oven for overnight sintering (150° C., 0.1 MPa, 15 h), followed by exposure to humid conditions in an autoclave (100° C., 0.1 MPa, 1 h, 97% RH) for final crystallization. Humidity-induced crystallization is caused by surface adsorption of water molecules, which results in partial dissolution and reprecipitation of the CaCO₃ into a more stable, crystalline formation (Du et al., 2020). After such treatment, printed models exhibited shape retention without dimensional distortions or significant structural cracks or fractures and allowed the removal of the binder by means of low-temperature sintering (FIG. 1D-F). Owing to the limited thermal stability of ACC and its susceptibility to spinodal decomposition (Polishchuk et al., 2017; Seknazi et al., 2019), sintering was carried out at a maximum temperature of 150° C. This significant decrease in sintering temperatures is essential for energy conservation purposes.

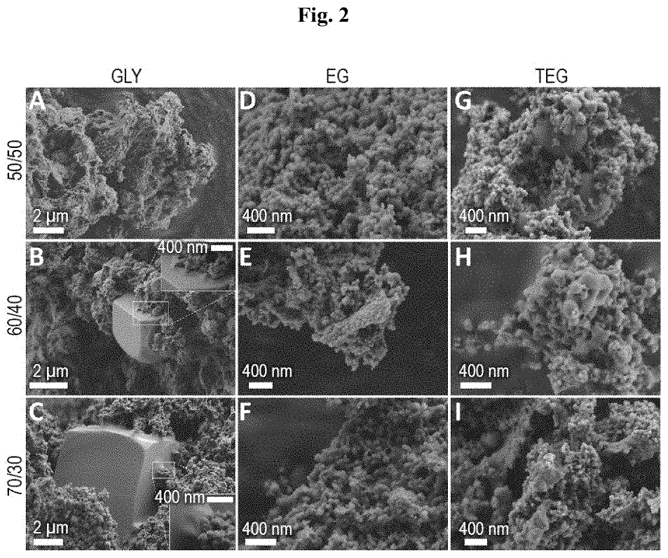

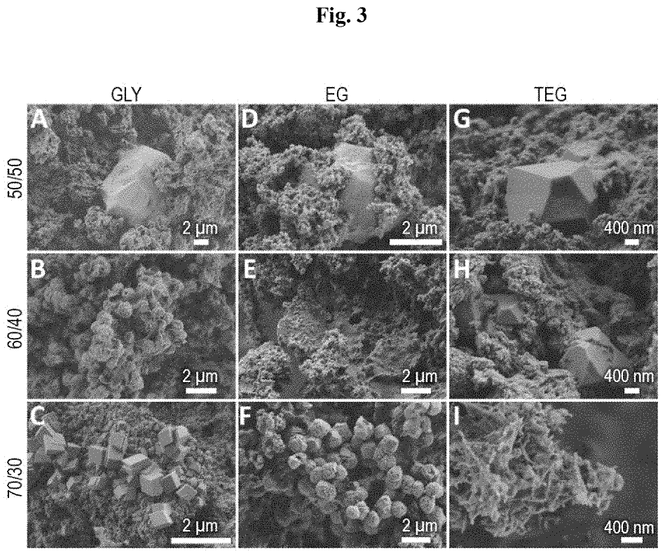

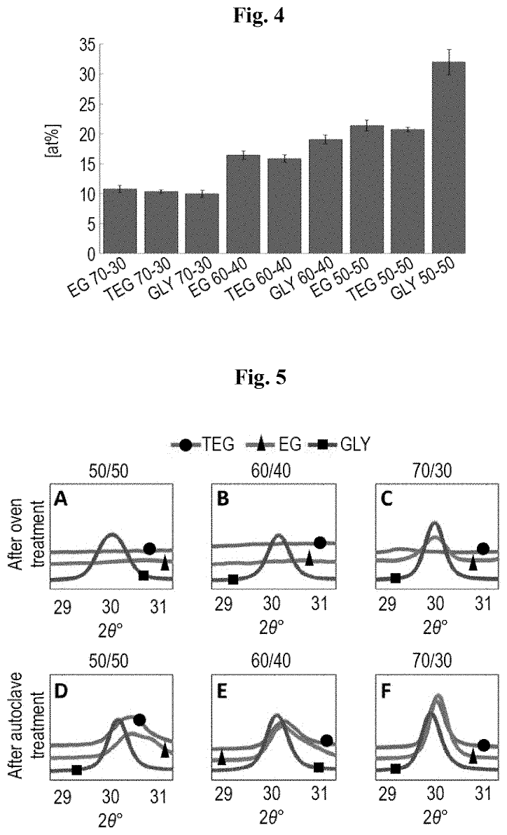

Morphology and composition. Changes in morphology, depending on the binder used, were observed. In EG- and TEG-printed models, the spherical morphology of ACC was preserved after the sintering step (FIG. 2, panels D-I). TEG models (FIG. 2, panels G-I) present larger spheres that are a result of ACC coarsening. On the other hand, the crystalline morphologies of GLY 60/40 and 70/30 models revealed clear rhombohedral facets (FIG. 2, panels B-C), implying that for GLY models, crystallization had probably occurred during the sintering step. We believe that a ‘feeding-stock’ phenomenon takes place, leading to the possibility of slow-paced crystallization in which the ACC particles are used as a CaCO₃ reservoir, as observed in biomineralization in nature (FIG. 2, panels B-C, insets) (Han and Aizenberg, 2008; Raz et al., 2002). After autoclave treatment, the morphology changed drastically, and crystalline morphology can be seen in all models (FIG. 3).

Chemical compositions of the sintered ACC models and their respective Ca:Mg ratios were analyzed by means of EDS (FIG. 4). As expected, the 50/50 ACC models exhibited higher levels of Mg incorporation than those of 60/40 or 70/30 models. The highest level of incorporated Mg, with ˜36 at. %, was observed in the case of the 50/50 GLY model, the higher the Mg content, the more significant the difference in incorporation levels between GLY and the other binders. We assume that stabilization of ACC obtained with TEG and EG binders may result in faster diffusion routes for Mg ions, while the GLY binder boosts crystallization, altogether leading to more complicated diffusion routes which result in higher levels of Mg incorporation.

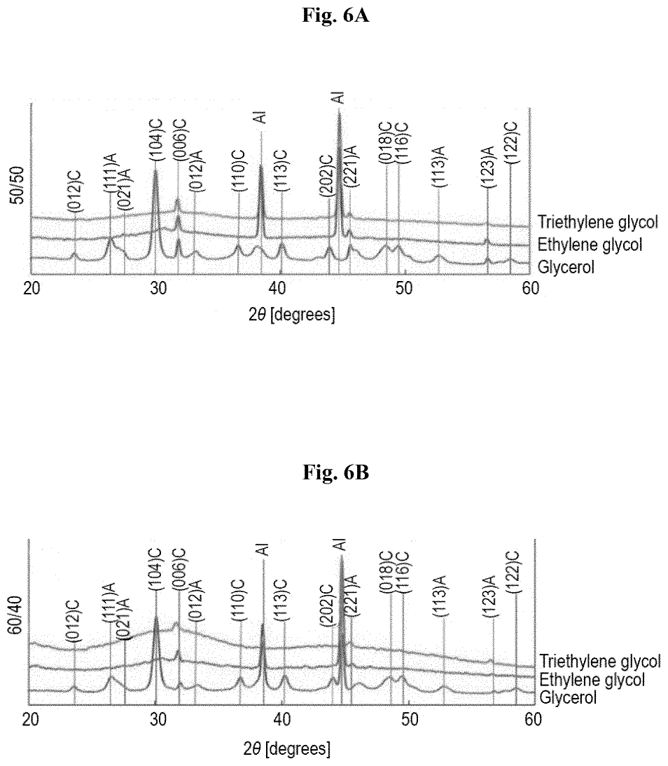

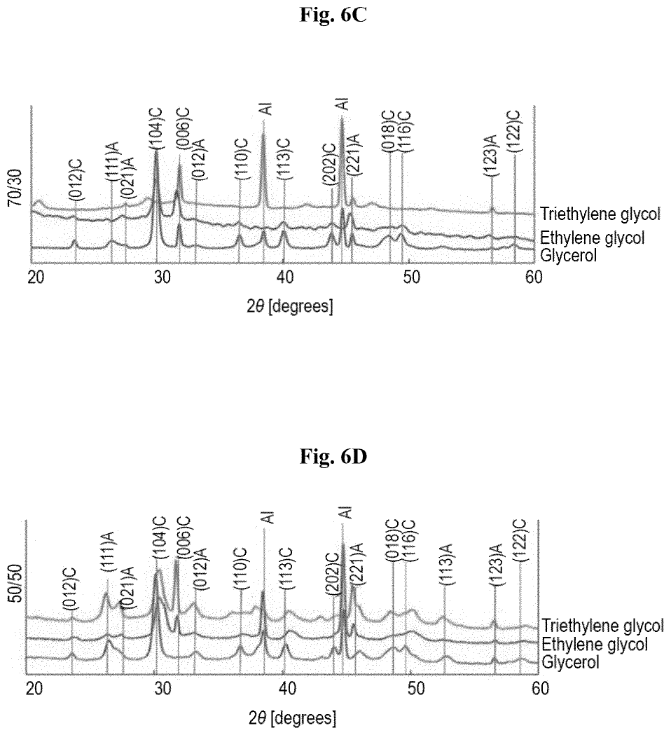

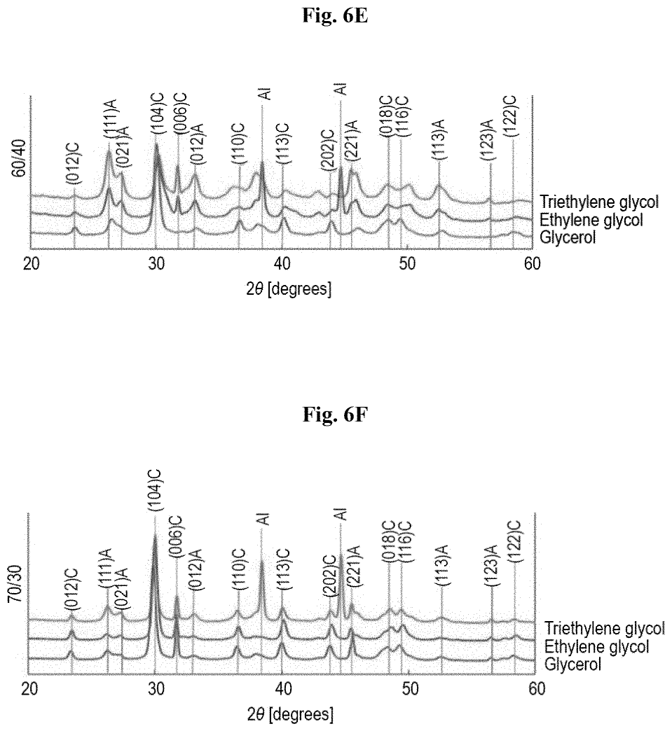

Crystallization of the ACC models. The relationship between the binder and the crystallization process was examined in both the oven sintering and the autoclave crystallization post-printing steps. After oven sintering, both the EG- and the TEG-stabilized ACC models preserved their amorphous nature, showing a very mild degree of crystallization. Preservation of ACC for long periods of time was proven possible either by unique synthesis routes resulting in minimal amounts of the product or by conservation in unique conditions; herein, we present ACC stabilization when preserved at ambient conditions for several months. The 70/30 models showed susceptibility to crystallization owing to their reduced stability associated with their lower levels of Mg incorporation (FIG. 5, panels A-C). The smallest amount of crystallization after oven sintering was that of calcite with its clear (006) preferred orientation, as well as of some aragonite revealing the (221) and (123) diffraction peaks (FIGS. 6A-6F). We believe that the (006) preferred orientation results from the organic environment of the printed models. On the other hand, the GLY-stabilized ACC model demonstrated complete crystallization after oven sintering, which can be attributed to its highly hygroscopic nature (Alber, 1938). The high-humidity environment within the autoclave facilitated rapid crystallization of all models, resulting in the formation of both calcite and aragonite phases (FIG. 5, panels D-F). Further evidence of Mg incorporation into the structure of the printed models during the amorphous-to-crystalline transformation is provided by the shift in the (104) diffraction peak position to higher 2θ angles (Mg is a smaller ion than Ca) (Bianco-Stein et al., 2020).

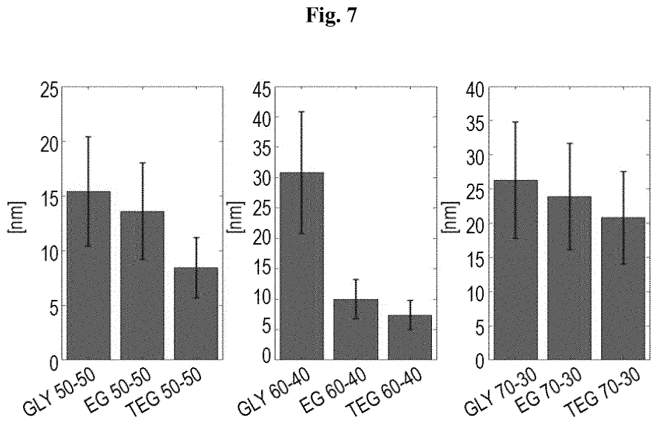

Profile fitting (Pokroy et al., 2006) of the (104) single-diffraction peak revealed a relationship between the binder and the crystallite size in printed models (FIG. 7). GLY was able to promote the formation of larger crystals than those formed with EG; the smallest crystals were observed when TEG was used as the binder. This trend was observed for all samples with varying Ca:Mg ratios, confirming a clear dependency between the grain size and the binder. GLY was the only binder that promoted slow crystallization during the oven treatment, whereas in the presence of either EG or TEG, crystallization was rapidly induced by the humid environment within the autoclave. Therefore, slower growth rates led to the formation of larger crystals, whereas rapid crystallization promoted the formation of smaller crystals.

### CONCLUSIONS

The present study demonstrates a novel bio-inspired approach to the printing of 3D complex structures using robocasting of printable, long-term stabilized ACC pastes with high solids loading (55-65%). Stabilization of ACC was achieved by the incorporation of foreign atoms such as Mg as well as by the storage environment. The amorphous nature of the obtained printable ACC pastes was retained for up to some months, even after low temperature sintering at 150° C. The post-sintered printed ACC 3D models exhibited no shrinkage and maintained their initial dimensions and complex shapes. We further showed that the choice of the binder affected the amount of incorporated Mg, as well as the stabilization and the final morphology of the ACC models. EG and TEG preserved the amorphous nature of the ACC models for up to several months after printing, whereas GLY boosted their crystallization possibly due to its highly hygroscopic nature. GLY also facilitated the formation of larger crystals with higher Mg incorporation. In addition, GLY presented a ‘feeding-stock’ morphology resembling that of ACC during its transformation to a crystalline phase in nature, thereby serving as a CaCO₃ reservoir enabling the formation of large crystals with unique morphologies and enhanced characteristics. This novel approach to 3D printing of ACC may highlight the advantages of this phase as a precursor to crystalline CaCO₃ and open new routes to energy-efficient 3D printing of ceramics for multiple applications.

### REFERENCES

Alber, H. K., Hygroscopic substances in microanalysis, Mikrochemie 25 (1938) 167-181, https://doi.org/10.1007/BF02714760
Bianco-Stein, N.; Polishchuk, I.; Seiden, G.; Villanova, J.; Rack, A.; Zaslansky, P.; Pokroy, B., Helical microstructures of the mineralized coralline red algae determine their mechanical properties, Adv. Sci. 7 (2020) 2000108, https://doi.org/10.1002/advs.202000108
Chen, T.; Sun, A.; Chu, C.; Wu, H.; Wang, J.; Wang, J.; Li, Z.; Guo, J.; Xu, G., Rheological behavior of titania ink and mechanical properties of titania ceramic structures by 3D direct ink writing using high solid loading titania ceramic ink, J. Alloys Compd. 783 (2019a) 321-328, https://doi.org/10.1016/j.jalicom.2018.12.343
Chen, Z.; Li, Z.; Li, J.; Liu, C.; Lao, C.; Fu, Y.; Liu, C.; Li, Y.; Wang, P.; He, Y., 3D printing of ceramics: a review, J. Eur. Ceram. Soc. 39 (2019b) 661-687, https://doi.org/10.1016/j.jeurceamsoc.2018.11.013
Du, H.; Courregelongue, C.; Xto, J.; Böhlen, A.; Steinacher, M.; Borca, C. N.; Huthwelker, T.; Amstad, E., Additives: their influence on the humidity- and pressure induced crystallization of amorphous CaCO₃, Chem. Mater. 32 (2020) 4282-4291, https://doi.org/10.1021/acs.chemmater.0c00975
Ferreira, J. M. F.; Diz, H. M. M., Effect of solids loading on slip-casting performance of silicon carbide slurries, J. Am. Ceram. Soc. 82 (1999) 1993-2000, https://doi.org/10.111/j.1151-2916.1999.tb02031.x
Han, T. Y.-J.; Aizenberg, J., Calcium carbonate storage in amorphous form and its template-induced crystallization y, Chem. Mater. 20 (2008) 1064-1068, https://doi.org/10.1021/cm702032v
Leu, M. C.; Deuser, B. K.; Landers, R. G.; Hilmas, G. E.; Watts, J. L., Freeze-form extrusion fabrication of functionally graded materials, CIRP Ann.—Manuf Technol. (2012) 61, https://doi.org/10.1016/j.cirp.2012.03.050
Mohan, D.; Khairullah, N. F.; How, Y. P.; Sajab, M. S.; Kaco, H., 3D printed laminated CaCO₃-nanocellulose films as controlled-release 5-fluorouracil, Polymers 12 (2020) 986, https://doi.org/10.3390/polym12040986
Murali Krishnan, J.; Deshpande, A. P.; Sunil Kumar, P., Rheology of Complex Fluids, Springer New York, N.Y., N.Y., 2010, https://doi.org/10.1007/978-1-4419-6494-6
Peng, E.; Zhang, D.; Ding, J., Ceramic robocasting: recent achievements, potential, and future developments, Adv. Mater. 30 (2018) 1802404, https://doi.org/10.1002/adma.201802404
Pokroy, B.; Fitch, A.; Zolotoyabko, E., The microstructure of biogenic calcite: a view by high-resolution synchrotron powder diffraction, Adv. Mater. 18 (2006) 2363-2368, https://doi.org/10.1002/adma.200600714
Polishchuk, I.; Bracha, A. A.; Bloch, L.; Levy, D.; Kozachkevich, S.; Etinger-Geller, Y.; Kauffmann, Y.; Burghammer, M.; Giacobbe, C.; Villanova, J.; Hendler, G.; Sun, C. Y.; Giuffre, A. J.; Marcus, M. A.; Kundanati, L.; Zaslansky, P.; Pugno, N. M.; Gilbert, P. U. P. A.; Katsman, A.; Pokroy, B., Coherently aligned nanoparticles within a biogenic single crystal: a biological prestressing strategy, Science 358 (2017) 1294-1298, https://doi.org/10.1126/science.aaj2156
Raz, S.; Testeniere, O.; Hecker, A.; Weiner, S.; Luquet, G., Stable amorphous calcium carbonate is the main component of the calcium storage structures of the Crustacean Orchestia cavimana, Biol. Bull. 203 (2002) 269-274, https://doi.org/10.2307/1543569
Ryabenkova, Y.; Pinnock, A.; Quadros, P. A.; Goodchild, R. L.; M€obus, G.; Crawford, A.; Hatton, P. V.; Miller, C. A., The relationship between particle morphology and rheological properties in injectable nano-hydroxyapatite bone graft substitutes, Mater. Sci. Eng. C 75 (2017) 1083-1090, https://doi.org/10.1016/j.msec.2017.02.170
Seknazi, E.; Kozachkevich, S.; Polishchuk, I.; Bianco Stein, N.; Villanova, J.; Suuronen, J. P.; Dejoie, C.; Zaslansky, P.; Katsman, A.; Pokroy, B., From spinodal decomposition to alternating layered structure within single crystals of biogenic magnesium calcite, Nat. Commun. 10 (2019) 1-9, https://doi.org/10.1038/s41467-019-12168-8
Shaaneield, D. J., Organic Additives and Ceramic Processing, with Applications in Powder Metallurgy, Ink and Paint, 1995
Travitzky, N.; Bonet, A.; Dermeik, B.; Fey, T.; Filbert-Demut, I.; Schlier, L.; Schlordt, T.; Greil, P., Additive manufacturing of ceramic-based materials, Adv. Eng. Mater. 16 (2014) 729-754, https://doi.org/10.1002/adem.201400097
Wei, J.; Li, J.; Song, X.; Feng, Y.; Qiu, T., Effects of solid loading on the rheological behaviors and mechanical properties of injection-molded alumina ceramics, J. Alloys Compd. 768 (2018) 503-509, https://doi.org/10.1016/j.jallcom.2018.07.036
Zima, A.; Czechowska, J.; Siek, D.; Slosarczyk, A., Influence of magnesium and silver ions on rheological properties of hydroxyapatite/chitosan/calcium sulphate based bone cements, Ceram. Int. 43 (2017) 16196-16203, https://doi.org/10.1016/j.ceramint.2017.08.197

What is claimed is:

1. A paste comprising amorphous calcium carbonate (ACC) doped with divalent alkaline-earth- or transition metal ions, a binder, and optionally a dispersant.

2. The paste of claim 1, wherein said divalent alkaline-earth metal ions are magnesium (Mg) ions; and said divalent transition metal ions are zinc (Zn) or manganese (Mn) ions.

3. The paste of claim 2, wherein said ACC is doped with Mg ions.

4. The paste of claim 1, wherein said binder comprises a polar organic solvent or a mixture thereof.

5. The paste of claim 4, wherein said polar organic solvent is an alcohol, diol or polyol such as ethoxymethanol, ethoxyethanol, ethylene glycol, triethylene glycol, propylene glycol, glycerol, and pentaerythritol; dimethylformamide (DMF); or dimethyl sulfoxide (DMSO).

6. The paste of claim 1, wherein said dispersant is an oil such as a vegetable oil (e.g., corn oil, coconut oil, canola oil, and sunflower oil), fish oil, and oil paint, glycerol, or a mixture thereof.

7. The paste of claim 6, wherein said vegetable oil is corn oil, coconut oil, canola oil, or sunflower oil.

8. The paste of claim 1, wherein the ratio between said doped ACC and said dispersant in said paste is about 1 grain to 0-0.25 mL, respectively; or the ratio between said doped ACC and the total volume of said dispersant and said binder in said paste is about 1-2 gram to 1 mL, respectively.

9. The paste of claim 1, wherein the ratio between the calcium ions of said CaCO₃ and said divalent alkaline-earth- or transition metal ions is from about 4:1 to about 1:1.

10. The paste of claim 1, comprising ACC doped with Mg ions; ethylene glycol or triethylene glycol as said binder; and corn oil as said dispersant, wherein the ratio between the calcium ions of said CaCO₃ and said Mg ions is about 1:1.

11. The paste of claim 1, having a viscosity in the range of about 2×10⁵ to about 5×10⁵ cP, at a temperature of 25° C. and a constant shear rate of 10 sec⁻¹.

12. A dry three-dimensional (3D) model prepared from a paste according to claim 1.

13. The dry 3D model of claim 12, prepared by a process comprising 3D-printing process.

14. The dry 3D model of claim 13, wherein said 3D-printing process is robocasting 3D-printing process.

15. A process for the preparation of a paste according to claim 1, comprising the steps of:
(i) mixing an aqueous solution containing calcium ions and an aqueous solution containing said divalent alkaline-earth- or transition metal ions, to obtain a solution, and then adding an aqueous solution containing carbonate ions, optionally while stirring, to obtain a suspension;
(ii) filtering said suspension to obtain a filtered powder;
(iii) washing said filtered powder and consequently drying it;
(iv) grinding the dried powder obtained in step (iii) and optionally mixing with said dispersant; and
(v) mixing the product obtained in step (iv) with said binder to obtain said paste.

16. The process of claim 15, wherein the aqueous solutions mixed in step (i) are CaCl₂.2H₂O, MgCl₂.6H₂O, and Na₂CO₃ solutions.

17. The process of claim 15, wherein the ratio between said calcium ions, and said divalent alkaline-earth- or transition metal ions in the aqueous solutions mixed in step (i) is from about 4:1 to about 1:1, respectively.

18. The process of claim 15, wherein said filtered powder is washed in step (iii) with water and optionally an organic solvent such as acetone, isopropanol, and diethyl-ether.

19. The process of claim 15, wherein said washed filtered powder is dried in step (iii) at room temperature, optionally under vacuum.

20. The process of claim 15 wherein said binder comprises a polar organic solvent or a mixture thereof; and said dispersant is an oil such as a vegetable oil, fish oil, and oil paint, glycerol, or a mixture thereof.

21. The process of claim 20, wherein said polar organic solvent is an alcohol, diol or polyol such as ethoxymethanol, ethoxyethanol, ethylene glycol, triethylene glycol, propylene glycol, glycerol, and pentaerythritol; dimethylfomamide (DMF); or dimethyl sulfoxide (DMSO).

22. The process of claim 15, wherein the ratio between the grinded powder obtained in step (iv) and said dispersant is 1 gram to 0-0.25 mL, respectively.

23. The process of claim 15, wherein the ratio between the grinded powder obtained in step (iv) and the total volume of said dispersant and said binder mixed in steps (iv) and (v) is about 1-2 gram to 1 mL, respectively.

24. The process of claim 15, further comprising the steps of:
(vi) printing a 3D model using a 3D-printing process, e.g., a robocasting 3D-printing process; and
(vii) drying said model to obtain a crystalline CaCO₃ doped with said divalent alkaline-earth- or transition metal ions.

25. The process of claim 24, wherein said 3D-printing process is robocasting 3D-printing process.

26. The process of claim 24, wherein said drying is carried out by sintering at a temperature not exceeding 200° C., such as at about 140° C.-160° C., under vacuum condition; and/or using an autoclave and/or a vacuum oven.
